(19) United States
(12) Patent Application Publication
(10) Pub. No.: US 2025/0266013 A1
(43) Pub. Date: Aug. 21, 2025

(54) DATA PROCESSING DEVICE, DATA DRIVING DEVICE, AND DISPLAY DEVICE INCLUDING THE SAME

(71) Applicant: LX SEMICON CO., LTD., Daejeon (KR)

(72) Inventors: Do Seok KIM, Daejeon (KR); Myung Yu KIM, Daejeon (KR)

(73) Assignee: LX SEMICON CO., LTD., Daejeon (KR)

(21) Appl. No.: 19/054,782

(22) Filed: Feb. 15, 2025

(30) Foreign Application Priority Data
Feb. 16, 2024 (KR) 10-2024-0022499
Feb. 14, 2025 (KR) 10-2025-0019220

(51) Int. Cl. G09G 5/00

(52) U.S. Cl. CPC G09G 5/003; G09G 2370/10

(57) ABSTRACT

A data processing device includes a first main communication circuit configured to transmit configuration data and image data via a first communication line; a first auxiliary communication circuit configured to send and receive a lock signal via a second communication line; and a register configured to store configuration data based on vendor identification information. The first main communication circuit is configured to transmit a first request packet requesting vendor identification information, select configuration data based on the received vendor identification information, and transmit the selected configuration data via the first communication line.

### CROSS-REFERENCE TO RELATED APPLICATIONS

This application claims the priorities of Korean Patent Applications No. 10-2024-0022499, filed on Feb. 16, 2024 and No. 10-2025-0019220, filed on Feb. 14, 2025, which are hereby incorporated by reference in their entirety.

### BACKGROUND

### Field of the Disclosure

The present disclosure relates to techniques for driving a display device.

### Description of the Background

Display panels are composed of a plurality of pixels arranged in a matrix. Each pixel may have colors such as R (red), G (green), and B (blue), and displays images on the display panel by emitting light according to the grayscale based on image data.

The image data is transferred from a data processing device, such as a timing controller, to a data driving device, such as a source driver. While the image data is transmitted as digital values, the data driving device converts the image data into analog voltages to drive each pixel.

Unlike the timing controller, source drivers do not have an external memory for setting options, so the options are set using the pins or the timing controller. In general, panel manufacturers or set manufacturers employ a single set of configuration option values regardless of the type of the source drivers, and the configuration options of the source drivers for each vendor (manufacturer) are not separately managed.

However, for various reasons, the configuration options of the source drivers are manufactured differently by each vendor (manufacturer). Therefore, it is necessary to set the options differently, depending on which vendor produced the source drivers that make up the system.

### SUMMARY

The present disclosure is to provide a data processing device, a data driving device, and a display device including the same, which are capable of setting the options of the source drivers differently by vendors.

The problems to be solved by the present disclosure are not limited to those mentioned above, and other problems not mentioned will be clearly understood by those skilled in the art from the following description.

A data processing device according to one aspect of the present disclosure includes: a first main communication circuit configured to transmit configuration data and image data via a first communication line; a first auxiliary communication circuit configured to send and receive signals via a second communication line; and a plurality of registers configured to store configuration data for each vendor, wherein the first main communication circuit is configured to: transmit a first configuration packet requesting vendor identification information, select configuration data from the plurality of registers based on received vendor identification information, and transmit the selected configuration data via the first communication line.

A data driving device according to one aspect of the present disclosure includes: a second main communication circuit configured to receive configuration data and image data via a first communication line; a second auxiliary communication circuit configured to send and receive signals via a second communication line; and a reception control part (reception controller) configured to control the second main communication circuit and the second auxiliary communication circuit, wherein the reception control part is configured to: transmit its own vendor identification packet via the second communication line in response to receiving a first configuration packet requesting vendor identification information via the first communication line.

A display device according to one aspect of the present disclosure includes: a data processing device; and a plurality of data driving devices, wherein the data processing device is configured to send a first configuration packet that requests vendor identification information to each of the plurality of data driving devices, the plurality of data driving devices each is configured to transmit its vendor identification information to the data processing device in response to the first configuration packet, and the data processing device is configured to transmit selected configuration data based on received vendor identification information to each of the plurality of data driving devices.

According to the aspects, the option of the source driver may be set differently for each vendors by confirming the vendor identification information. As a result, a high-speed data transmission environment may be optimized.

In addition, it is possible to manage options for each vendor without increasing production cost and complexity.

The effects of the present disclosure are not limited to the above-mentioned effects, and other effects that are not mentioned will be apparently understood by those skilled in the art from the following description and the appended claims.

### BRIEF DESCRIPTION OF THE DRAWINGS

The above and other objects, features, and advantages of the present disclosure will become more apparent to those of ordinary skill in the art by describing exemplary aspects thereof in detail with reference to the attached drawings, in which:

FIG. 1 is a conceptual diagram of a display device according to an aspect of the present disclosure;

FIG. 2 is a configuration diagram of a data processing device and a data driving device according to an aspect of the present disclosure;

FIG. 3 is a diagram illustrating a display device according to an aspect of the present disclosure;

FIG. 4 is a diagram illustrating an option selection circuit of the data processing device according to an aspect of the present disclosure;

FIG. 5 is a modified example of FIG. 4;

FIG. 6 is a diagram illustrating the main communication and the auxiliary communication between the data processing device and the data driving device according to an aspect of the present disclosure;

FIG. 7 is a diagram illustrating the main communication and the auxiliary communication between the data processing device and the data driving device according to another aspect of the present disclosure;

FIG. 8 is a diagram illustrating the sequence of transmission signals according to an aspect of the present disclosure;

FIG. 9 is a diagram illustrating a structure of a first configuration packet according to an aspect of the present disclosure;

FIG. 10 is a configuration diagram of blank data and line data according to an aspect of the present disclosure; and

FIG. 11 is a diagram showing the data flow of the data processing device and the data driving device according to an aspect of the present disclosure.

### DETAILED DESCRIPTION

The advantages and features of the present disclosure, and methods of achieving them will be apparent from the aspects described in detail below in conjunction with the accompanying drawings. However, the present disclosure is not limited to the following aspects, which may be implemented in various different forms; rather, the present aspects are provided to make the disclosure of the present disclosure complete and to allow those skilled in the art to fully understand the scope of the present disclosure, and the present disclosure is defined only within the scope of the appended claims.

The shapes, sizes, proportions, angles, numbers and the like shown in the accompanying drawings for the purpose of describing the aspects of the present disclosure are merely examples, and the present disclosure is not limited thereto. Like reference numerals generally denote like elements throughout the present specification. Further, in describing the present disclosure, detailed descriptions of known related technologies may be omitted so as not to unnecessarily obscure the subject matter of the present disclosure.

The following aspects may be combined or associated with each other in whole or in part, and various types of interlocking and driving are technically possible. The aspects may be implemented independently of each other or together in an interrelated relationship.

Hereinafter, various aspects of the present disclosure will be described in detail with reference to the accompanying drawings.

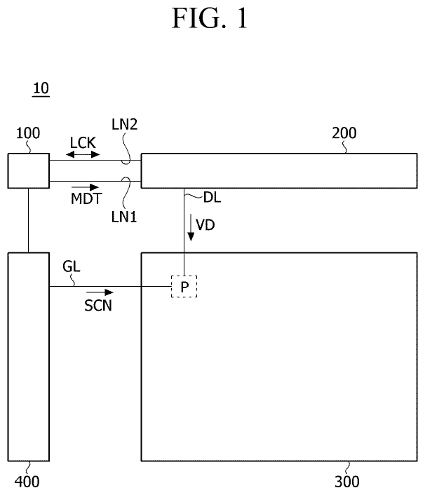

FIG. 1 is a conceptual diagram of a display device according to an aspect of the present disclosure.

Referring to FIG. 1, a display device 10 may include a data processing device 100, a data driving device 200, a display panel 300, and a gate driving device 400.

The data processing device 100 may receive image data from the other device. The other device may be a host that generates the image data.

The data processing device 100 may process the image data received from the other device to be suitable for the data driving device 200, and transmit the processed image data to the data driving device 200. The data processing device 100 may perform digital gamma correction processing on a greyscale value of each pixel included in the image data or may perform compensation processing on the greyscale value to match the characteristics of the pixel.

The data driving device 200 may receive the image data from the data processing device 100, generate data voltages VD according to the greyscale values of the pixels included in the image data, and supply the data voltages VD to the pixels P.

A plurality of pixels P may be arranged on the display panel 300. In addition, each pixel P may be connected to the data driving device 200 via a data line DL and to the gate driving device 400 via a gate line GL.

The display panel 300 may be a panel of a flat-panel display device, such as a liquid crystal display (LCD), a field emission display (FED), a plasma display panel (PDP), an organic light-emitting display (OLED), or a non-organic light-emitting display.

Each pixel P may include a transistor, where the gate terminal of the transistor may be connected to the gate line GL, and the source terminal thereof may be connected to the data line DL. When the gate driving device 400 supplies a scan signal SCN to the gate line GL, the transistor turns on, connecting the data line DL to the pixel P. After the data line DL is connected to the pixel P, the data voltage VD supplied by the data driving device 200 is transferred to the pixel P.

To synchronize the timing of the gate driving device 400 and the data driving device 200, the data processing device 100 may send a timing control signal to the gate driving device 400 and the data driving device 200.

The data processing device 100 may send a gate control signal to the gate driving device 400. The gate control signal may include the aforementioned timing control signal. The gate driving device 400 may generate the scan signal SCN based on the gate control signal and supply the scan signal SCN to the pixel P via the gate line GL.

At least two types of communication lines LN1 and LN2 may be arranged between the data processing device 100 and the data driving device 200. The data processing device 100 may send a first communication signal MDT via the first communication line LN1 and may send or receive a second communication signal LCK via the second communication line LN2.

The first communication line LN1 may be defined as a main communication line, and the second communication line LN2 may be defined as an auxiliary communication line. The first communication signal MDT may be defined as a main communication signal, and the second communication signal LCK may be defined as an auxiliary communication signal.

The data processing device 110 may send the image data and the timing control signals to the data driving device 120 via the main communication signal MDT, and the data driving device 120 may send status information to the data processing device 110 via the auxiliary communication signal LCK.

When the data processing device 100 or the data driving device 200 performs a specific operation, it may mean that various hardware included in the data processing device 100 or the data driving device 200, for example, a controller such as a micro controlling unit (MCU), a field programmable gate array (FPGA), an application specific integrated circuit (ASIC), and/or a microprocessor, performs a specific operation. When the data processing device 100 or the data driving device 200 performs a specific operation, it may mean that the controller controls the other hardware to perform a specific operation.

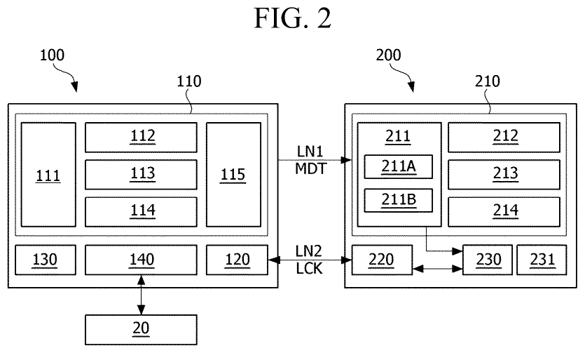

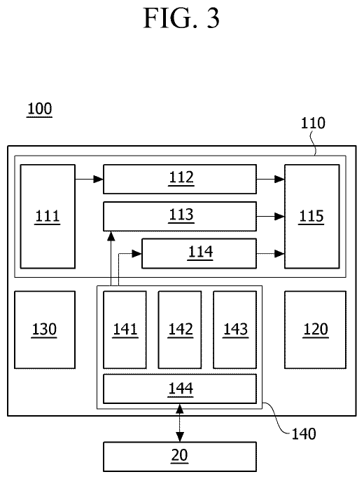

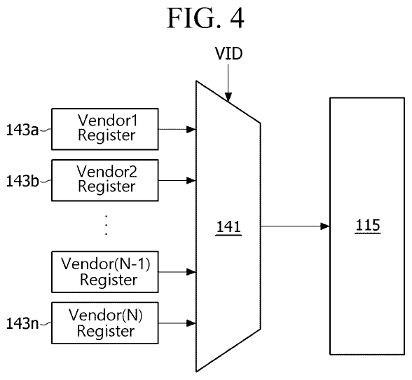

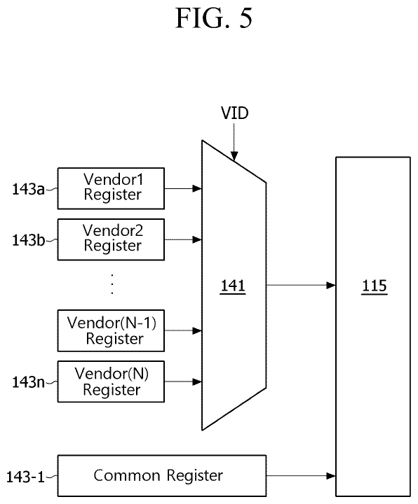

FIG. 2 is a configuration diagram of the data processing device and the data driving device according to an aspect. FIG. 3 is a diagram illustrating a display device according to an aspect of the present disclosure. FIG. 4 is a diagram illustrating an option selection circuit of the data processing device according to an aspect of the present disclosure. FIG. 5 is a modified example of FIG. 4.

Referring to FIGS. 2 and 3, the data processing device 100 may include a first main communication circuit 110, a first auxiliary communication circuit 120, and a transmission control part 130. The data driving device 200 may include a second main communication circuit 210, a second auxiliary communication circuit 220, and a reception control part 230. The first main communication circuit 110 may communicate with the second main communication circuit 210 via the first communication line LN1, and the first auxiliary communication circuit 120 may communicate with the second auxiliary communication circuit 220 via the second communication line LN2.

The first main communication circuit 110 may send the main communication signal MDT to the data driving device 200 via the first communication line LN1. The first main communication circuit 110 may send image data and first control data during an active interval via the first communication line LN1 and may send second control data during a blank interval via the first communication line LN1.

The data driving device 200 may drive the pixels of the display panel according to the image data. The first control data may include control values applied on a line-by-line or pixel-by-pixel basis to the display panel, while the second control data may include control values applied over longer cycles than line-by-line or pixel-by-pixel, or control values applied on a frame-by-frame basis.

The first main communication circuit 110 may send configuration data at a first data rate via the first communication line LN1. Subsequently, the first main communication circuit 110 may send the image data, the first control data, and the second control data at a second data rate, higher than the first data rate, via the first communication line LN1. The mode in which communication is performed at the first data rate may be defined as a low-speed communication mode, and the mode in which communication is performed at the second data rate may be defined as a high-speed communication mode.

The first main communication circuit 110 may receive image data, control data, and configuration data, convert the received image data, control data, and configuration data according to different encoding methods, and output the converted data. The first main communication circuit 110 may include a first high-speed communication circuit for converting image data and control data, and a second low-speed communication circuit for converting configuration data.

The first high-speed communication circuit may receive image data and control data, convert the received image data and control data according to different encoding methods, and output the converted data. The first high-speed communication circuit may include a receiver 111 that receives image data from an external source, a first data converter 112, a second data converter 113, and a transmitter 115.

The first data converter 112 may encode the image data and transmit it to the transmitter 115. The second data converter 113 may encode the control data and transmit it to the transmitter 115. The encoding method of the first data converter 112 and the encoding method of the second data converter 113 may be different from each other, but they are not limited thereto.

The first low-speed communication circuit may be configured to include a third data converter 114 and the transmitter 115. The first high-speed communication circuit and the first low-speed communication circuit may share the transmitter 115. The transmitter 115 may achieve the effect of transmitting at a low speed by using various methods such as increasing data transmitted from the first low-speed communication circuit. However, the aspect is not limited to that described above. For example, the high-speed transmitter of the first high-speed communication circuit and the low-speed transmitter of the first low-speed communication circuit may be provided separately from each other.

The third data converter 114 of the first low-speed communication circuit may encode the configuration data in a predetermined manner and then transmit the same through the transmitter 115. The configuration data, which is transmitted at a low speed, may include the configuration values for the data driving device 200 required before high-speed communication. For example, the configuration data may include configuration values for the circuits in the data driving device 200 that perform high-speed communication.

Referring to FIG. 3, the data processing device 100 may include an option selection circuit 140. The option selection circuit 140 may include a plurality of registers 143 in which a plurality of configuration data are respectively stored for each vendor, and a first data selector 141 for selecting one of the configuration data stored in the plurality of registers 143 according to a vendor identification number from the data driving device 200.

The option selection circuit 140 may be configured as a separate circuit from the first main communication circuit 110 or may be included in the first main communication circuit 110. The option selection circuit 140 may further include an option storage part in which configuration options of the receiver 111, the data converter 112, 113, 114, and the transmitter 115 are stored.

The plurality of registers 143 may each store configuration data for each vendor. The configuration data may be set differently for each vendor. This is because even for the same products, their internal configurations may be newly developed and applied for each vendor, and even for the same specifications, their characteristics may differ due to differences in analog circuit design methods for each vendor. For example, different vendors may have different bias voltages, different equalizer design techniques, different design techniques of a clock recovery part, and different internal configurations of driver ICs (e.g., digital-to-analog converters). As a result, it may be difficult to optimize if a high-speed data environment is built with uniform configuration data without considering vendor-specific options.

The optional selection circuit 140 may further include an input/output interface 144 that is connected to the external memory 20. The input/output interface 144 may load configuration values stored in the external memory 20 when power is applied. Data loaded through the input/output interface 144 may be stored in each of the plurality of registers 143. The input/output interface 144 may be any one of I2C, SPI, UART, or various memory interfaces.

The external memory 20 may include any one of a wide range of volatile or nonvolatile memories, including a random access memory (RAM), a read-only memory (ROM), a non-volatile random access memory (NVRAM), an electrically erasable and programmable ROM (EEPROM), a FLASH memory, and the like.

The data processing device 100 may transmit a first configuration packet requesting identification information to the data driving device 200 in configuration mode. For example, the transmission control part 130 may control the first main communication circuit 110 and the option selection circuit 140. The transmission control part 130 may control the first main communication circuit 110 to transmit the first configuration packet in the configuration mode.

The identification information may include vendor identification information, product codes, and the like. The vendor identification information may be unique identification information (vendor specific information) of the vendor (manufacturer) that manufactures the data driving devices.

The product codes are unique identification information (product specific information or product identification information) for a specific vendor's products to distinguish between the data driving devices from the same vendor.

The first auxiliary communication circuit 120 may receive vendor identification information and/or product code information transmitted from the data driving device 200. The transmission control part 130 may control the first data selector 141 based on the received vendor identification information and/or product code information. For example, when each configuration data of a first vendor, a second vendor, and a third vendor are stored in the plurality of registers 143, and the identification information of the second vendor is received, the transmission control part 130 may select a register 143 in which the configuration data of the second vendor is stored, and transmit the configuration data stored in that register 143 to the data driving device 200.

According to an aspect, the selected configuration data based on the vendor identification information may be transmitted to the third data converter 114. The third data converter 114 may encode the configuration data and transmit the same to the transmitter 115. The third data converter 114 may transmit the configuration data by encoding it with a Menchester code, but the encoding method is not limited to this. However, the aspects are not limited thereto. If the configuration data is not encoded, the configuration data may be transmitted directly to the data driving device 200 through the transmitter 115 without passing through the second data converter 113. In this case, a clock bit and a data error check bit may be added.

Referring to FIG. 4, a plurality of registers 143a 143b, 143n may be connected to the first data selector 141 for each vendor. The first data selector 141 may include a multiplexer. The transmission control part 130 may input a control signal VID to the first data selector 141 so that a register 143 matching the received vendor identification information is selected. Therefore, the configuration data stored in the selected register 143 may be forwarded to the transmitter 115.

Referring to FIG. 5, the register 143 may be provided with a plurality of registers 143a 143b, and 143n in which individual configuration data are respectively stored, and a common register 143-1 in which common configuration data are stored.

The configuration data may include common configuration data applied equally to all vendors and individual configuration data set differently for each vendor.

The common configuration data may include data corresponding to basic operation options such as resolution, color depth, timing control, scramble enable/disable, and test mode.

The individual configuration data may be data that varies depending on each vendor's design techniques and processes, such as receiving PHY (e.g., clock data restoration method/equalizer), bias/current control, and buffer operating current (Amp Current), etc.

The common configuration data may be stored in the common register 143-1, and the individual configuration data may be stored in a plurality of registers 143a 143b, 143n.

Upon receiving the vendor identification information, the transmission control part 130 may first transmit the common configuration data stored in the common register 143-1. Subsequently, it may input a control signal VID to the first data selector 141 so that a register matching the vendor identification information is selected among the plurality of registers 143a 143b, 143n, and secondly transmit the configuration data stored in the selected register.

According to an aspect, some of the common configuration data stored in the external memory may be updated to specific vendor-only configuration data using firmware and then transmitted. For example, if the system environment changes, the changed information may be updated in the external memory 20 and then the updated configuration data may be stored in the common register 143-1. By transmitting the updated configuration data in the common register 143-1 to the data driving device 200, it is possible to set the communication environment with the latest updated information for the changed environment.

However, the aspect is not limited to that described above. For example, after confirming the vendor identification information, the configuration data stored in the common register 143-1 may be transmitted first, and then the configuration data in the individual register 143 may be updated using firmware and transmitted second. MCUs and MCU BUSs may be designed as ASICs to update data by applying such firmware.

Referring to FIGS. 2 and 3, not only configuration data but also control data may be selected for each vendor based on the vendor identification information. Since not only the configuration data but also the frame control method and the line control method may be different for each vendor, it is necessary to optimize the control data together with the configuration data according to the vendor.

The control data as well as the configuration data may be stored in the plurality of registers 143. Alternatively, the configuration data for each vendor and the control data for each vendor may be stored in different registers 143.

The control data may include first control data and second control data. The first control data may include control values applied on a line-by-line or pixel-by-pixel basis to the display panel, while the second control data may include control values applied over longer cycles than line-by-line or pixel-by-pixel, or control values applied on a frame-by-frame basis. The first control data and the second control data may be stored in the plurality of registers 143 for each vendor. However, the aspect is not limited to that described above. The first control data and the second control data may be stored in different registers 143.

The option selection circuit 140 may include a second data selector 142 for selecting control data matching the vendor identification information from among a plurality of registers 143 in which the control data are stored. The second data selector 142 may include, but is not limited to, the same multiplexer as the first data selector 141.

The control data selected by the second data selector 142 may be converted into packets by the second data converter 113 and encoded with predetermined rules. The encoded control data may be transmitted to the data driving device 200 through the transmitter 115. However, the aspects are not limited thereto. If the control data is not encoded, the control data may be transmitted directly to the data driving device 200 through the transmitter 115 without passing through the second data converter 113.

The first auxiliary communication circuit 120 may receive the auxiliary communication signal LCK or send the auxiliary communication signal LCK to the second communication line LN2.

The first auxiliary communication circuit 120 may confirm the auxiliary communication signal LCK received from the second communication line LN2 and send a signal having the same form as the auxiliary communication signal LCK to the second communication line LN2 when the auxiliary communication signal LCK indicates an abnormality of the data driving device 200.

The data driving device 200 may include a second main communication circuit 210, a second auxiliary communication circuit 220, and a reception control part 230.

The second main communication circuit 210 may receive the main communication signal MDT via the first communication line LN1. The second main communication circuit 210 may receive optimized configuration data for each vendor via the first communication line LN1 in the configuration mode to establish a high-speed environment.

Subsequently, the second main communication circuit 210 may receive the image data, the first control data, and the second control data at a second data rate, which is higher than the first data rate, via the first communication line LN1. The second main communication circuit 210 may receive the image data and the first control data optimized for each vendor during the active interval in the display mode, and may receive the second control data optimized for each vendor during the blank interval in the display mode.

The second main communication circuit 210 may include a clock data recovery part 211A and a parallelizer 211B. The clock data recovery part 211A may perform clock training on signals that contain a training pattern. The clock data recovery part 211A may recover the clock by performing the clock training. The clock recovery part 211A may recover data using the recovered clock, and when the recovered data matches the reference data, the recovered clock may be used for communication with the data processing device 100.

The clock data recovery part 211A may receive clock training pattern signals as its input, generate output signals, and invert a lock signal from a low logic level to a high logic level when the phase and frequency of the output match those of the input clock, and then recover the clock to generate internal clocks having multi-phases. The clock data recovery part 211A may generate and output these multi-phase internal clocks using a phase-locked loop (PLL) technique or a delay-locked loop (DLL) technique.

The clock data recovery part 211A may synchronize the rising edge of the multi-phase internal clocks with each bit of control data packets and image data packets to recover the bits of the control and image data.

The parallelizer 211B may convert serial data into parallel data. The parallelizer 211B may receive the clock recovered by the clock data recovery part 211A and parallelize the data received from the data processing device 100 through the use of the recovered clock.

The second auxiliary communication circuit 220 may confirm abnormal states of the main communication signal MDT, the main communication circuit, and/or other components, and generate a status signal.

The reception control part 230 may transmit its vendor identification information to the data processing device 100 via the second communication line LN2 in response to a request to confirm the vendor identification information. The vendor identification information may be stored in internal registers or may be generated in the form of a one-time password (OTP). This means that the vendor identification information is not restricted to any storage method or storage medium, as long as it is in a form that may be transferred at least once upon request.

When the clock training is completed, the reception control part 230 may control the second auxiliary communication circuit 220 to output the lock signal at a high level. When a lock-fail occurs, the reception control part 230 may control the second auxiliary communication circuit 220 to output the lock signal at a low level. Further, upon receiving a first configuration packet requesting the vendor identification information from the data processing device 100, the reception control part 230 may control the second auxiliary communication circuit 220 to output its own vendor identification information stored in the register 143 to the second communication line LN2.

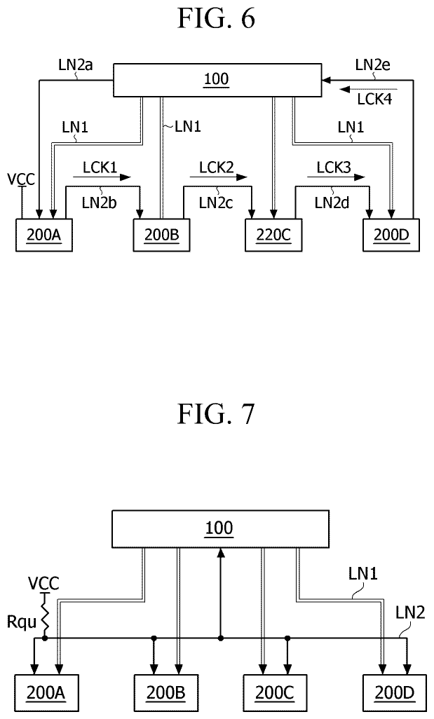

FIG. 6 is a diagram illustrating the main communication and the auxiliary communication between the data processing device and the data driving device according to an aspect of the present disclosure. FIG. 7 is a diagram illustrating the main communication and the auxiliary communication between the data processing device and the data driving device according to another aspect of the present disclosure.

Referring to FIG. 6, the data driving device 200 may be composed of a plurality of data driving devices 120A, 120B, 200C, and 200D. The first communication line LN1 may be connected one-to-one to each data driving part 200A, 200B, 200C, and 200D. The data processing device 100 and the plurality of data driving devices 200A, 200B, 200C, and 200D may send and receive various information via the second communication line LN2.

Between the plurality of data driving devices 200A, 200B, 200C, and 200D, the second communication line LN2 may be connected in cascade forming a plurality of lock links. The first data driving device 200A may receive signals from the data processing device 100 via a first lock line LN2a. The first data driving device 200A and the second data driving device 200B may be connected via a second lock line LN2b, while the second data driving device 200B and the third data driving device 200C may be connected via a third lock line LN2c. The third data driving device 200C and the fourth data driving device 200D may be connected via a fourth lock link LN2d, and the fourth data driving device 200D may be connected to the data processing device 100 via a feedback link LN2e.

The first to fourth data driving devices 200A to 200D may transmit lock signals using the lock lines. A lock signal is used to indicate whether or not clock training is complete. If the lock signal is at a high level (or low level), it may signify that clock training is complete. If the lock signal is at a low level (or high level), it may signify that clock training is incomplete. A lock-fail may signify either that clock training has not been completed or that the link between the data processing device 100 and the data driving device 200 has been broken.

The data processing device 100 may transmit a first configuration packet to the first data driving device 200A via the first communication line LN1. Upon receipt of the first configuration packet, the first data driving device 200A may forward its vendor identification information to the second data driving device 200B. The vendor identification information of the first data driving device 200A may be sequentially transmitted to the second data driving device 200B, the third data driving device 200C, and the fourth data driving device 200D. The fourth data driving device 200D may transmit to the data processing device 100 the vendor identification information of the first data driving device 200A. Thereafter, the data processing device 100 may transmit the first configuration packet to the second data driving device 200B. In this manner, the vendor identification information may be received from the plurality of data driving devices 200A to 200D by forwarding the first configuration packet to each of the data driving devices 200A to 200D in sequence.

Referring to FIG. 7, the data processing device 100 and the plurality of data driving devices 200A, 200B, 200C, and 200D may be connected in one-to-one via a plurality of first communication lines LN1. Further, the data processing device 100 and the plurality of data driving devices 200A, 200B, 200C, and 200D may be connected via a second communication line LN2, configured as a common bus.

The second communication line LN2 may be a single signal line driven by an open-drain configuration. A pull-up resistor Rqu may be connected to the second communication line LN2, where one side of the pull-up resistor Rqu is connected to the second communication line LN2, and the other side is supplied with a driving voltage VCC.

A plurality of data driving devices 200A to 200D may be connected to the second communication line LN2, and a multi-drop may be implemented by such connection.

In this case, the data processing device 100 may transmit a first configuration packet to the first data driving device 200A via the first communication line LN1. The first data driving device 200A may transmit its vendor identification information via the second communication line LN2, which is configured as a common bus. In this manner, the data processing device 100 may receive vendor identification information of the plurality of data driving devices 200A, 200B, 200C, and 200D by time-division control.

According to an aspect, a first configuration packet requesting vendor identification information may be transmitted via the first communication line LN1, and the vendor identification information of each data driving device 200A to 200D may be received via the second communication line LN2. However, the aspects are not limited thereto. For example, the data processing device 100 may request vendor identification information for each of the data driving devices 200A to 200D over the second communication line LN2.

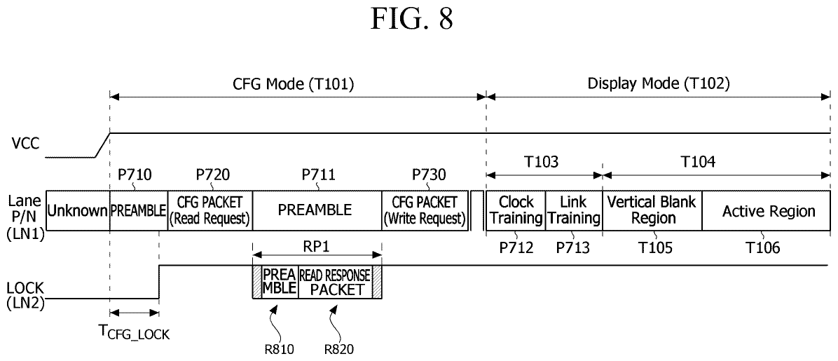

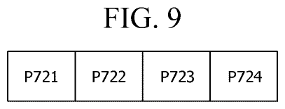

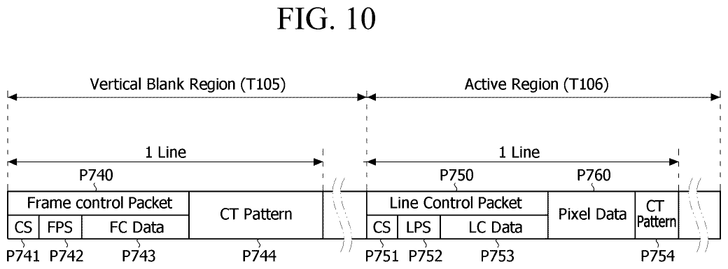

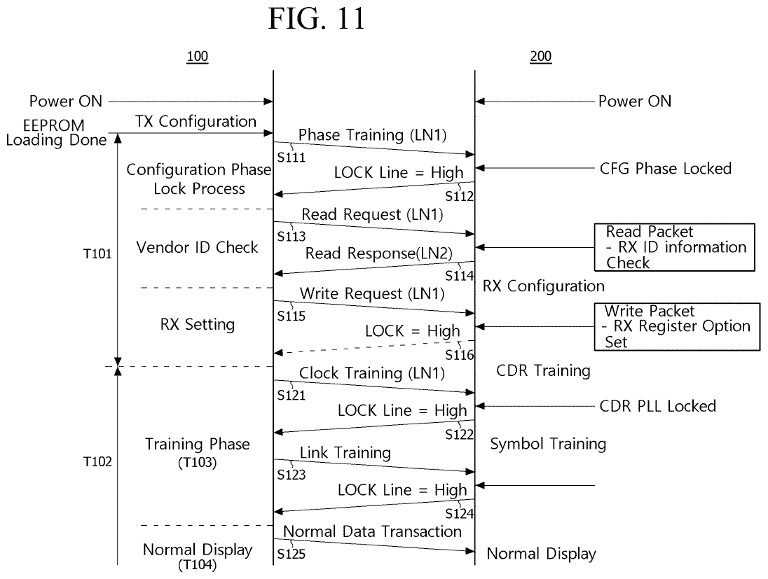

FIG. 8 is a diagram illustrating the sequence of transmission signals according to an aspect of the present disclosure. FIG. 9 is a diagram illustrating a structure of a vendor identification information requesting packet according to an aspect of the present disclosure. FIG. 10 is a configuration diagram of blank data and line data according to an aspect of the present disclosure. FIG. 11 is a diagram showing the data flow of the data processing device and the data driving device according to an aspect of the present disclosure.

Referring to FIGS. 8 to 11, the driving voltage VCC may initially maintain its waveform at a low-level voltage and then transition its waveform to a high-level voltage waveform at a certain point in time. The time at which the driving voltage VCC transitions to a high-level voltage may correspond to the driving timing of the display driving device.

After the driving timing, the data processing device 100 and the data driving device 200 may operate in the configuration mode, CFG mode (T101). After the operation in the configuration mode T101 is completed, the data processing device 100 and the data driving device 200 may operate in the display mode, Display Mode (T102).

In the configuration mode T101, the data processing device 100 may send a preamble packet P710, on the main communication signal MDT. The data driving device 200 may train a low-speed communication clock for receiving the configuration packet P720, using the preamble packet P710, which is configured with a clock training pattern. The preamble packet may be defined as a low-speed clock training pattern or a first clock training pattern. The data driving device 200 may train the low-speed communication clock using the preamble packets P710 (S111).

When the low-speed communication clock is trained within a predefined time period TCFG_LOCK, the data driving device 200 may inform the data processing device 100 of the clock training status on the auxiliary communication signal. For example, once the low-speed communication clock has been trained, the data driving device 200 may alter the voltage level of the auxiliary communication signal from low to high (S112).

After confirming from the auxiliary communication signal that the data driving device 200 has trained the low-speed communication clock, the data processing device 100 may transmit a first configuration packet P720 (S113).

The first configuration packet P720 may be composed of a start bit P721, a header P722, body data P723, and an end bit P724. The header P722 may include mode selection information and read mode information, and the body data P723 may include read address information and read length information.

The mode selection information may include a default mode, a bypass mode, a test mode, and a read mode. The default mode may be a normal mode that operates as a configuration mode and a display mode. The read mode may be a mode that receives vendor identification information from the data driving device. The test mode may be a mode that perform different kinds of tests. The bypass mode may be a mode that skips a relevant step. The data driving device that needs to be tested during the test may operate in the test mode, and the remaining data driving devices may operate in the bypass mode. The mode selection information may be composed of four bits to implement four modes. For example, the default mode may be 0000, the bypass mode may be 0011, the test mode may be 1100, and the read mode may be 1111. However, the aspects are not limited thereto.

The read mode information may be a 1-bit signal consisting of either high or low levels. The read address information may be information about a start address to be read from a register map of the data driving device 200. The read length information may be the length of information to be read. Therefore, it is possible to obtain vendor identification information by reading a predetermined length from a predetermined location.

The plurality of data driving device 200 may operate according to the command defined in the first configuration packet P720.

When driving in the read mode, the data processing device 100 may transmit the first configuration packet SPI in which the mode selection information is in the read mode to the plurality of data driving devices 200. In this case, to sequentially receive the vendor identification packet, the data processing device 100 may transmit read mode information at a high level to only one of the data driving devices 200 and transmit read mode information at a low level to the remaining data driving devices 200.

When the received read mode information is at a high level, the corresponding data driving device 200 may transmit its own vendor identification packet via the second communication line LN2. The remaining data driving device 200 in which the received read mode information is at a low level may maintain the second communication line at a high level and wait.

As such, the data processing device 100 may receive the vendor identification packet by sequentially transmitting the read mode information to the plurality of data driving devices 200 at a high level.

When receiving the vendor identification packet from all the data driving devices 200, the data processing device 100 may change the mode selection information to the default mode and operate in the configuration mode. Thereafter, when the configuration mode ends, the data processing device 100 may switch to the display mode.

When the data driving device 200 receives the first configuration packet P720 instructing it to operate in the read mode, it may transmit its own vendor identification packet R820 together with a preamble pattern R810, via the second communication line LN2 (S114).

When certain pattern information is transmitted together with the preamble pattern R810 from the data driving device 200, the data processing device 100 may recognize it as a vendor identification packet R820 for that data driving device 200.

According to an aspect, during the read mode, the data processing device 100 may transmit a preamble pattern P711, to the data processing device 100 via the first communication line LN1, and the data driving device 200 may transmit a preamble pattern R810, and a vendor identification packet R820, to the data processing device 100 via the second communication line LN2. During a read mode period RP1, a clock signal sent by the data processing device 100 and a clock signal transmitted by the data driving device 200 may be asynchronous with each other.

The first communication line LN1 has a lower transmission speed than the second communication line LN2, and has a pull-up resistor or the like, which that makes it difficult to drive at high speed. Accordingly, the data driving device 200 may be configured to transmit the vendor identification information using a default clock generated by an internal oscillator. According to this configuration, since the data processing device 110 uses a clock that is not synchronized with the clock of the preamble pattern P711 received via the first communication line LN1, a data phase lock time for synchronizing the preamble clock received by the data processing device 100 may be increased.

However the aspects are not limited thereto. For example, the data driving device 200 may be configured to transmit the vendor identification packet R820 using a clock of a preamble pattern that has completed training. For example, the data driving device 200 may transmit the vendor identification packet R820 after slowly modulating the clock frequency of the preamble pattern by dividing the clock frequency. In this case, information about how much to divide the clock frequency of the preamble pattern may be stored in advance in the body data P723 of the first configuration packet P720.

Accordingly, the data driving device 200 may adjust the clock frequency of the preamble pattern according to the frequency of the transmission clock stored in the body data P723 of the first configuration packet P720 and transmit the vendor identification packet R820 according to the adjusted clock. Such a configuration may allow the data processing device 100 to reduce the clock synchronization time.

However, the aspects are not limited thereto. When the preamble pattern P711 is a Manchester code, the data driving device may transmit the preamble pattern R810 and the vendor identification packet R820 using the preamble pattern P711 as a clock. The transmitted vendor identification packet R820 may be half as long as the preamble. In this case, there is an advantage in that a separate frequency divider circuit may be omitted.

When receiving the vendor identification packet R820, the data driving device 200 may read the value stored in one of the plurality of registers 143 that matches the vendor identification information, and store the value as the configuration data.

The data driving device 200 may transmit configuration data P730 matching the vendor identification information to the data driving device 200 (S115). When the data driving device 200 receives the configuration data P730, it may maintain a lock signal at a high level (S116). The data driving device 200 may read the received configuration data P730 to establish a high-speed communication environment according to the settings therein.

After the configuration mode T101 ends, the data processing device 100 and the data driving device 200 may transition to the display mode T102. The display mode T102 may be composed of a clock training period T103 and a frame period T104. Once the high-speed communication clock P730 has been trained during the clock training period T103, the frame period T104 may occur repeatedly.

During the clock training period T103, the data processing device 100 may send a clock training pattern P712, to the data driving device 200 at the second data rate. The data driving device 200 may train high-speed communication clock corresponding to the second data rate according to the clock training pattern P712. Here, the second data rate may have a higher frequency than the first data rate.

Once the clock training for the high-speed communication clock is complete, the data driving device 200 may maintain the lock signal at a high level (S122). Once the clock training for the high-speed communication clock is complete, the data processing device 100 may transmit a link training pattern P713. Once the link training is complete, the data driving device 200 may maintain the lock signal at a high level. Once the link training is complete, the data processing device 100 may enter a normal data transmission period where control data and image data are transmitted (S125).

In the display mode, the frame period T104 may include an active interval T106 and a blank interval T105. The active interval T106 may be a period during which image data and control data are sent on a line-by-line basis, while the blank interval T105 may be a period during which line-by-line image data is not sent. The blank interval T105 may be divided into a horizontal blank interval and a vertical blank interval.

The frame period T104 may include an active interval T106 and a blank interval T105. The active interval T106 may be a period during which image data and control data are sent on a line-by-line basis, while the blank interval T105 may be a period during which line-by-line image data is not sent. The blank interval T105 may be divided into a horizontal blank interval and a vertical blank interval, and for ease of explanation, it will be described that the blank interval T105 is a vertical blank interval.

As shown in FIG. 10, during the blank interval T105, the data processing device 100 may send a frame control packet P740 on a line-by-line basis. The frame control packet P740 may include a control start packet, CS, P741, a frame start packet, FPS, P742, and a frame data packet, FC Data, P743.

The control start packet P741 may indicate the start of a control packet. The frame start packet P742 may indicate the start of transmission of frame data. Therefore, it is possible to distinguish whether the data to be transmitted after the control start signal is frame data or line data.

The frame data packet P743 may contain configuration values that are changed on a frame-by-frame basis or may not be changed from time to time. The frame clock training pattern may contain pattern signals to train the high-speed communication clock. According to an aspect, the configuration values in the frame data packet may be set differently depending on the vendor identification information.

During the blank interval T105, the data processing device 100 may enter the active interval T106 after sending blank data packets for all lines.

During the active interval T106, the data processing device 100 may send a line control packet P750, an image packet P760, and a line clock training pattern P754, on a line-by-line basis.

The line control packet P750 may be composed of a control start packet P751, a line start packet P752, and a line data packet P753. The control start packet P751 may indicate the start of the line control packet P750, and the line start packet P752 may indicate the start of the transmission of the line data.

The line data packet P753 may contain configuration values that are changed on a line-by-line basis or may be changed from time to time. For example, the line data packet P753 may include a polarity value indicating the polarity of each pixel, may include a value indicating whether or not a scrambler 414 has been reset, and may include control information indicating whether the video data is valid data or dummy data. According to an aspect, the configuration values in the line data packet may be set differently depending on the vendor identification information.

The image packet P760 may contain the grayscale values of the pixels disposed on a line. The line clock training pattern P754 may include a pattern signal to train the high-speed communication clock.

During the active interval T106, the data processing device 100 may enter the blank interval T105 again after sending the line control packets for all lines.

The term “˜part” used in the aspects refers to software or hardware components such as field-programmable gate arrays (FPGA) or ASIC, where the “˜part” performs certain roles. However, “˜part” is not limited to software or hardware. The “˜part” may be configured to be on an addressable storage medium or may be configured to play one or more processors. Thus, as an example, “˜part” includes software components, components such as object-oriented software components, class components, and task components, processes, functions, properties, procedures, subroutines, segments of program code, drivers, firmware, microcode, circuits, data, databases, data structures, tables, arrays, and variables. The functions provided within the components and “˜parts” may be combined into fewer components and “˜parts”, or further separated into additional components and “˜parts”. In addition, the components and “˜parts” may be implemented to play one or more CPUs within the device or secure multimedia card.

While aspects of the present disclosure have been described in more detail with reference to the accompanying drawings, the present disclosure is not necessarily limited to these aspects and may be practiced in various modifications without departing from the spirit of the present disclosure. Therefore, the aspects disclosed in the present disclosure are provided for illustrative purposes only and are not intended to limit the technical concept of the present disclosure, and the scope of the technical concept of the present disclosure is not limited thereto. Therefore, it should be understood that the aspects described above are illustrative in all aspects and do not limit the present disclosure.

### LIST OF REFERENCE NUMBERS

100: Data processing device
110: First main communication circuit
120: First auxiliary communication circuit
130: Transmission control part
140: Option selection circuit
200: Data driving device
210: Second main communication circuit
220: Second auxiliary communication circuit
230: Reception control part

What is claimed is:

1. A data processing device comprising:
a first main communication circuit configured to transmit configuration data and image data via a first communication line;
a first auxiliary communication circuit configured to send and receive signals via a second communication line; and
a plurality of registers configured to store configuration data for each vendor,
wherein the first main communication circuit is configured to:
transmit a first configuration packet requesting vendor identification information, select configuration data from the plurality of registers based on received vendor identification information, and transmit the selected configuration data via the first communication line.

2. The data processing device of claim 1, wherein the first main communication circuit is configured to: transmit a preamble pattern via the first communication line and transmit the first configuration packet via the first communication line when receiving a lock signal of the preamble pattern via the second communication line.

3. The data processing device of claim 2, wherein the first main communication circuit is configured to: receive the vendor identification information via the second communication line.

4. The data processing device of claim 2, wherein the data processing device is configured to transmit a preamble pattern via the first communication line during read mode period after requesting the first configuration packet.

5. The data processing device of claim 1, wherein the first main communication circuit is configured to transmit control data and image data at a second communication rate different from the first communication rate after the transmission of the selected configuration data is completed; and
the control data is set based on the received vendor identification information.

6. The data processing device of claim 1, wherein each of the plurality of registers stores configuration data for each vendor.

7. The data processing device of claim 1, wherein:
different individual configuration data for each vendor are stored in the plurality of registers,
common configuration data common to the vendors is stored in a common register, and
the first main communication circuit is configured to transmit the common configuration data stored in the common register when receive the vendor identification information, and transmit the different individual configuration data based on the vendor identification information.

8. The data processing device of claim 1, wherein the first main communication circuit further includes an input/output interface connected to an external memory; and
the first main communication circuit is configured to store configuration data stored in the external memory in the plurality of registers through the input/output interface.

9. A data driving device comprising:
a second main communication circuit configured to receive configuration data and image data via a first communication line;
a second auxiliary communication circuit configured to send and receive signals via a second communication line; and
a reception controller configured to control the second main communication circuit and the second auxiliary communication circuit,
wherein the reception controller is configured to transmit its own vendor identification packet via the second communication line in response to receiving a first configuration packet requesting vendor identification information via the first communication line.

10. The data driving device of claim 9, wherein the reception controller is configured to receive configuration data based on the vendor identification information to establish a high-speed transmission environment.

11. A display device comprising:
a data processing device; and
a plurality of data driving devices,
wherein the data processing device is configured to send a first configuration packet that requests vendor identification information to each of the plurality of data driving devices;
the plurality of data driving devices each is configured to transmit its vendor identification information to the data processing device in response to the first configuration packet; and
the data processing device is configured to transmit selected configuration data based on received vendor identification information to each of the plurality of data driving devices.

12. The display device of claim 11, wherein the data processing device is configured to transmit the first configuration packet via the first communication line; and
the plurality of data driving devices is configuration transmit the vendor identification information via the second communication line.

13. The display device of claim 12, wherein the data processing device is configured to transmit control data selected according to the vendor identification information to the plurality of data driving devices via the first communication line.
